(19) United States
(12) Patent Application Publication
(10) Pub. No.: US 2015/0009423 A1
(43) Pub. Date: Jan. 8, 2015

(54) TOUCH PANEL STRUCTURE, METHOD FOR FORMING THE SAME AND TOUCH DEVICE COMPRISING THE SAME

(71) Applicant: CANDO CORPORATION, Hsinchu County (TW)

(72) Inventors: CHUNG-CHI WANG, Hsinchu County (TW); YUN-WEN CHEN, Hsinchu County (TW); YAO-HUI HUANG, Hsinchu County (TW)

(73) Assignee: CANDO CORPORATION, Hsinchu County (TW)

(21) Appl. No.: 14/230,867

(22) Filed: Mar. 31, 2014

(30) Foreign Application Priority Data
Jul. 2, 2013 (TW) 102123598

(51) Int. Cl. G06F 1/16; G02B 5/22

(52) U.S. Cl. CPC G06F 1/169; G02B 5/22
USPC 349/12; 427/58

(57) ABSTRACT

The present invention discloses a touch panel structure, a method for forming the same and a touch device comprising the same. A touch panel structure of the present invention comprises a substrate, a color layer, and a shielding layer. The shielding layer is disposed on a surface of the color layer which is opposite to the substrate. The shielding layer has at least one hollow area, and the color layer has a transmittance of more than 1%. With the present invention, the logo and function key icons and their surrounding area on a touch device share a same color layer of the same material. Therefore, the visual color difference perceived by the user is eliminated.

### CROSS-REFERENCE TO RELATED APPLICATIONS

This non-provisional application claims priority under 35 U.S.C. §119(a) on Patent Application No(s). 102123598 filed in Taiwan on Jul. 2, 2013, the entire contents of which are hereby incorporated by reference.

### BACKGROUND OF THE INVENTION

1. Field of the Invention

The present invention relates to a touch panel structure and a method for forming the same. More particularly, the present invention relates to a touch panel structure which improves the issue of visual color difference perceived by the user; also, the present invention relates to a method for forming such a touch panel and to a touch device comprising the same.

2. Description of the Prior Art

As touch panel technology keeps advancing while consumer electronics gain increasing popularity in recent years, touchscreens are even more widely used in many products. Touchscreens used to be adopted in particular product categories, but now, a wide range of electronic product manufacturers have adopted touchscreen as a fundamental part of a product. Touchscreens have become a popular application that has a fast growing market.

FIG. 1 shows a conventional touch panel structure. As FIG. 1 shows, the conventional touch panel structure 1 comprises a black matrix photoresist layer 11 on a substrate 10, wherein the black matrix photoresist layer 11 has certain hollow areas which correspond to the positions of a logo and function key icons. The black matrix photoresist layer 11 is then coated with an ink layer 12 by screen printing technology; the ink layer 12 fills the hollow areas which correspond to the positions of a logo and function key icons and produces a nearly “invisible” effect. That is, for touch sensors panel that are manufactured using One Glass Solution (OGS) technology, the “invisible” effect of the logos and function key icons are achieved through the use of a black matrix photoresist layer 11 together with an ink layer 12 of a similar color which is coated by screen printing.

However, since the black matrix photoresist and the ink used with the prior art technique are of different materials, users are more easily to perceive the color difference. Consequently, the invisible effect of the icons on a touch panel is not good enough.

Hence, there exists a need in the market for a touch panel structure which improves the issue of visual color difference perceived by the user, so that the user is provided with better visual experience when using a touch device. Accordingly, a method for forming such a touch panel structure and a touch device comprising the touch panel structure are also needed.

### SUMMARY OF THE INVENTION

In view of the above drawbacks of the prior art technique, it is an aspect of the present invention to provide a touch panel structure, a method for forming the same and a touch device comprising the same, so that the visual color difference perceived by the user when using a touch device can be eliminated.

According to an aspect of the present invention, there is provided a touch panel structure comprising a substrate, a color layer, and a shielding layer. The color layer is disposed on a surface of the substrate. The shielding layer is disposed on a surface of the color layer which is opposite to the substrate, and the shielding layer has at least one hollow area. The color layer of the touch panel structure has a transmittance of more than 1%.

According to an aspect of the present invention, there is provided a method for forming a touch panel structure comprising: providing a substrate; providing a color layer on a surface of the substrate; and providing a shielding layer on a surface of the color layer which is opposite to the substrate, the shielding layer having at least one hollow area, wherein the color layer has a transmittance of more than 1%.

According to an aspect of the present invention, there is provided a touch device comprising the touch panel structure as described above.

The aforementioned aspects and other aspects of the present invention will be better understood with reference to the following exemplary embodiments and drawings.

### BRIEF DESCRIPTION OF THE DRAWINGS

FIG. 1 is a schematic view showing a prior art touch panel structure.

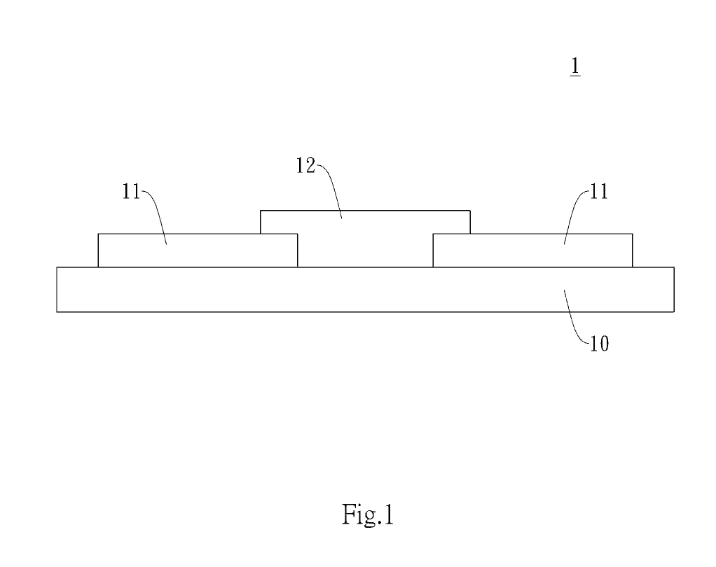

FIG. 2 is a cross-sectional view of a touch panel structure according to an embodiment of the present invention.

FIG. 3A is a first schematic view showing part of a touch panel structure according to an embodiment of the present invention.

FIG. 3B is a second schematic view showing another part of a touch panel structure according to an embodiment of the present invention.

FIG. 4A is a first schematic view showing part of a touch panel structure in a product example according to an embodiment of the present invention.

FIG. 4B is a second schematic view showing part of a touch panel structure in a product example according to an embodiment of the present invention.

FIG. 5 is a flow chart showing a method for forming a touch panel structure according to an embodiment of the present invention.

### DETAILED DESCRIPTION OF THE PREFERRED EMBODIMENTS

The present invention will be fully described by way of preferred embodiments and appended drawings to facilitate the understanding of the technical features, contents and advantages of the present invention. It will be understood that the appended drawings are merely schematic representations and may not be illustrated according to actual scale and precise arrangement of the implemented invention. Therefore, the present invention shall not be construed based on the scale and arrangement illustrated on the appended drawings, and the embodiments and appended drawings are not intended to limit the scope of protection of the present invention.

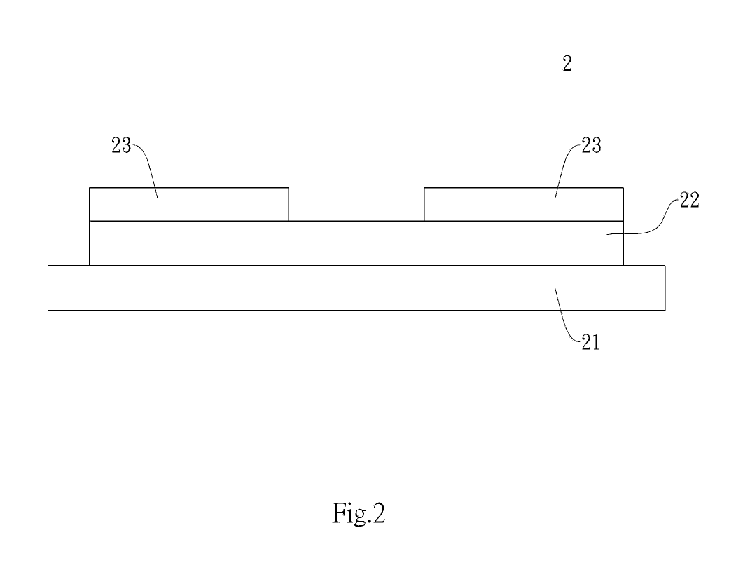

FIG. 2 is a cross-sectional view of a touch panel structure according to an embodiment of the present invention, illustrating the basic construction of the touch panel. As shown in FIG. 2, a touch panel structure 2 of the embodiment of present invention mainly comprises a substrate 21, a color layer 22, and a shielding layer 23. The color layer 22 may be disposed on a surface of the substrate 21, and preferably, the color layer 22 may have a transmittance of more than 1%. The shielding layer 23 may be disposed on a surface of the color layer 22 which is opposite to the substrate 21. In this embodiment, the color layer 22 is preferably an ink layer, and the shielding layer 23 is preferably a black matrix photoresist layer. However, in an actual implementation of the touch panel structure, the color layer 22 may be realized as an ink layer or a photoresist layer, and similarly, the shielding layer 23 may be realized as an ink layer or a photoresist layer.

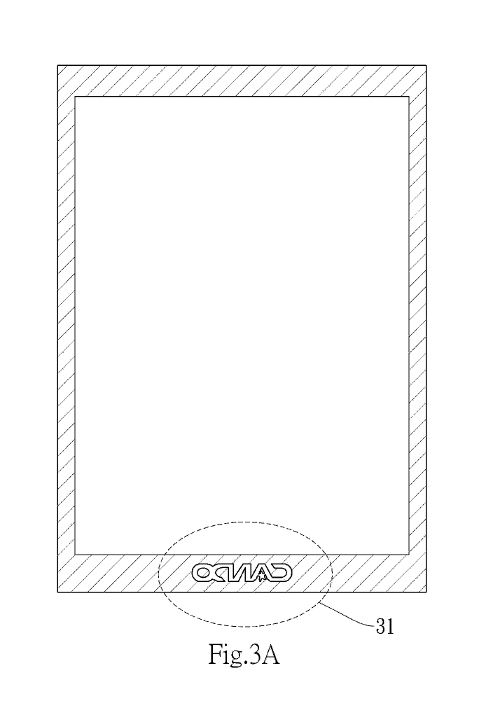

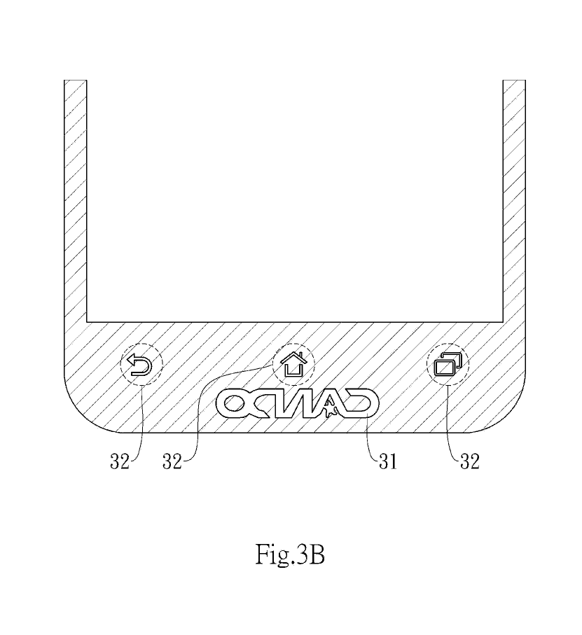

Particularly, the shielding layer 23 of the touch panel structure 2 has certain hollow areas which correspond to the positions of the logo and function key icons on an electronic product. Furthermore, the positions of the logo and function key icons on the touch panel are covered by the material of the color layer 22 only, and the light transmissive areas in the touch panel structure are formed by both the hollow areas of the shielding layer 23 and the color layer 22. For example, as shown in FIGS. 3A and 3B, the positions of the hollow areas are illustrated as dotted circles 31 and 32, which correspond to the positions of the logo and function key icons on the touch panel. The hatched area in FIGS. 3A and 3B shows the area that is not light transmissive.

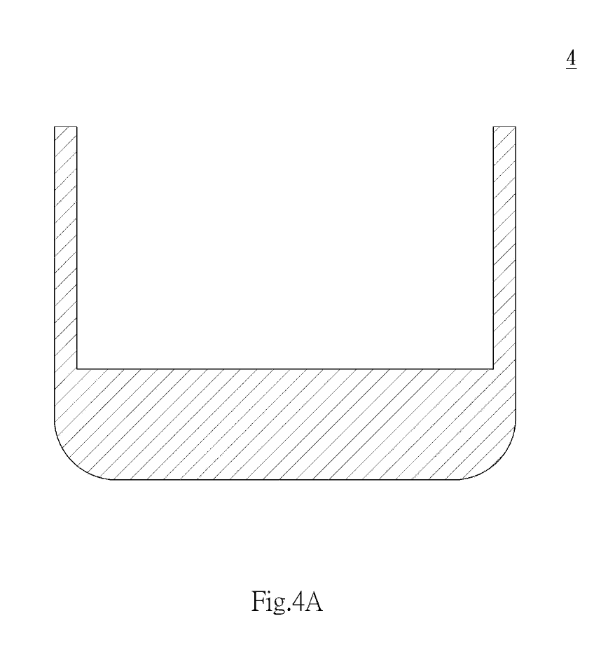

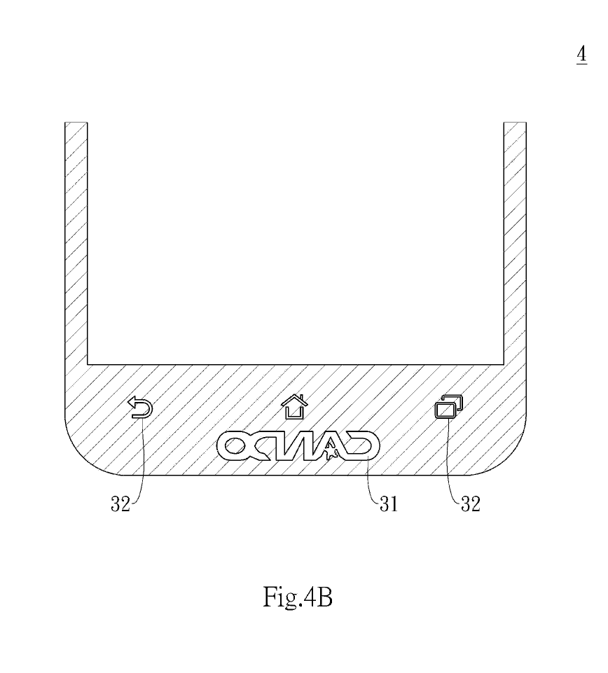

FIG. 4A is a first schematic view and FIG. 4B a second schematic view showing part of a touch panel structure in a product example according to an embodiment of the present invention. These two figures illustrate the effect produced by a touch panel structure according to the embodiment of present invention. A touch panel structure according to the embodiment of the present invention may be provided in a touch device 4, wherein the touch device 4 may be, for example, a touchscreen panel, a portable mobile device with a touchscreen, or an electronic appliance incorporating touch technology, but is not limited to these examples. In one embodiment of the present invention, as shown in FIG. 4A, when the backlight is not switched on, the color of the logo and function key icons look the same as the color of their surrounding area on the touch panel (as the hatched area in FIG. 3A shows). This is because the logo and function key icons and their surrounding area share a same color layer of the same material, and no color difference is produced. When the backlight is switched on, the areas of the logo 31 and the function key icons 32 will create a translucent effect (numerals 31 and 32 in FIG. 4B show the translucent areas; the hatched area in FIG. 4B represents the area that is not light transmissive).

It should be noted that a person having ordinarily knowledge in the art will understand that the aforementioned embodiments regarding the material of the color layer 22, the material of the shielding layer 23, and the hollow areas in the shielding layer 23, are exemplary and are not intended to limit the present invention. Any touch panel structure made without departing from the spirit and scope of the present invention falls within the scope of the present invention.

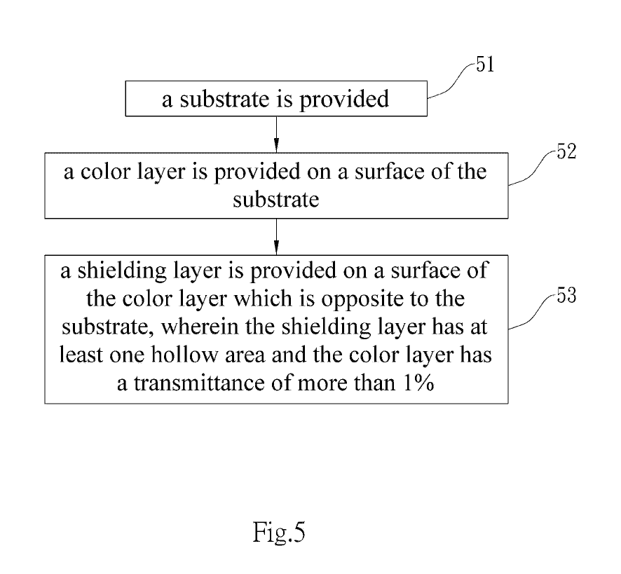

FIG. 5 is a flow chart showing a method for forming a touch panel structure according to an embodiment of the present invention. As FIG. 5 shows, a method for forming a touch panel structure according to the embodiment of present invention may comprise the following steps. In step 51, a substrate is provided. In step 52, a color layer is provided on a surface of the substrate. In step 53, a shielding layer is provided on a surface of the color layer which is opposite to the substrate, wherein the shielding layer has at least one hollow area and the color layer has a transmittance of more than 1%.

In sum, the embodiment of present invention provides a touch panel structure, a method for forming the same and a touch device comprising the same. The embodiment of present invention is advantageous in at least the following aspect: the logo and function key icons and their surrounding area on a touch device share a same color layer of the same material; therefore, the visual color difference perceived by the user is eliminated effectively. Moreover, the touch panel manufacturing process according to the present invention is simplified as compared with a conventional process.

The present invention, which includes a touch panel structure, a method for forming the same and a touch device comprising the same, has been described above by way of preferred embodiments with reference to the accompanying drawings. All of the advantageous features disclosed in this specification may be combined in any combination. Each feature disclosed in this specification may be replaced by an alternative feature serving the same, equivalent, or similar purpose. Thus, except for those particularly distinctive features, each feature disclosed is only an example of a generic series of equivalent or similar features. Given the above description of preferred embodiments, those skilled in the art would understand that the present invention features several aspects of novelty and inventive step over the prior art and is industrially applicable. Various modifications and substitutions may be made by those skilled in the art without departing from the spirit and scope of the present invention.

What is claimed is:

1. A touch panel structure, comprising:
a substrate;
a color layer disposed on a surface of the substrate; and
a shielding layer disposed on a surface of the color layer which is opposite to the substrate, the shielding layer having at least one hollow area, wherein the color layer has a transmittance of more than 1%.

2. The touch panel structure according to claim 1, wherein the at least one hollow area corresponds to a position of a logo or a function key icon on an electronic device.

3. The touch panel structure according to claim 1, wherein the color layer is an ink layer.

4. The touch panel structure according to claim 1, wherein the shielding layer is a black matrix layer.

5. A method for forming a touch panel structure, comprising:
providing a substrate;
providing a color layer on a surface of the substrate; and
providing a shielding layer on a surface of the color layer which is opposite to the substrate, the shielding layer having at least one hollow area, wherein the color layer has a transmittance of more than 1%.

6. The method according to claim 5, wherein the at least one hollow area corresponds to a position of a logo or a function key icon on an electronic device.

7. The method according to claim 5, wherein the color layer is an ink layer.

8. The method according to claim 5, wherein the shielding layer is a black matrix layer.

9. A touch device comprising a touch panel structure, the touch panel structure comprising:
a substrate;
a color layer disposed on a surface of the substrate; and
a shielding layer disposed on a surface of the color layer which is opposite to the substrate, the shielding layer having at least one hollow area, wherein the color layer has a transmittance of more than 1%.

10. The touch device according to claim 9, wherein the at least one hollow area corresponds to a position of a logo or a function key icon on an electronic device.
